(19) United States
(12) Patent Application Publication
(10) Pub. No.: US 2013/0189547 A1
(43) Pub. Date: Jul. 25, 2013

(54) Battery Banks, Connector Assemblies, and Battery Connecting Methods

(71) Applicants: Allan Coxon, Ford, WA (US); Alfred T. Volberding, Kirkland, WA (US); Shane Johnson, Rosalia, WA (US); Don Boggan, Spokane Valley, WA (US)

(72) Inventors: Allan Coxon, Ford, WA (US); Alfred T. Volberding, Kirkland, WA (US); Shane Johnson, Rosalia, WA (US); Don Boggan, Spokane Valley, WA (US)

(21) Appl. No.: 13/554,332

(22) Filed: Jul. 20, 2012

Related U.S. Application Data
(60) Provisional application No. 61/509,953, filed on Jul. 20, 2011.
(60) Provisional application No. 61/547,299, filed on Oct. 14, 2011.

(51) Int. Cl. H01M 2/20; H01R 11/28

(52) U.S. Cl. CPC H01M 2/202; H01M 2/204; H01M 2/206; H01R 11/281
USPC 429/7; 429/121; 429/99; 429/50; 29/825; 439/772

(57) ABSTRACT

Methods for controlling the usage of individual and/or groups of batteries within a bank of batteries are provided. Methods for connecting batteries are also provided. Battery connector boards are provided. Battery banks are also provided. Battery connector assemblies are provided.

### CROSS REFERENCE TO RELATED APPLICATION

This application claims priority to U.S. Provisional Patent Application No. 61/509,953 filed Jul. 20, 2011, entitled “Battery Connector Assemblies and Battery Connecting Methods” and U.S. Provisional Patent Application No. 61/547,299 filed Oct. 14, 2011, entitled “Battery Connector Assemblies and Battery Connecting Methods”, the entirety of each of which is incorporated by reference herein.

### TECHNICAL FIELD

The present disclosure relates to the connection of batteries for receipt, storage, and withdrawal of power. Embodiments of the disclosure relate to battery banks, connector assemblies and battery connecting methods.

### BACKGROUND

Recent advances in power distribution have utilized battery systems to store power generated and to deliver power as needed. These battery systems can include single-celled or multi-celled batteries, and they can take the form of nickel-metal-hydride or lithium ion batteries, for example.

Battery banks that include multiple individual batteries can be utilized for this purpose as well. Batteries within these banks may be single-celled batteries and can be aligned in parallel or series fashion, for example. Connecting the batteries within these banks to one another and/or to a power supply or receiver is not inconsequential. The present disclosure provides battery connector assemblies as well as battery connecting methods.

### SUMMARY

Methods for controlling the usage of individual and/or groups of batteries within a bank of batteries are provided. The methods can include: coupling an integrated circuit board to the batteries within the bank of batteries; monitoring the battery parameters of individual and/or groups of batteries within a bank of batteries; and engaging and/or disengaging the individual and/or groups of batteries through the circuit board.

Methods for connecting batteries are also provided. The methods can include: aligning a series of clamping assemblies along a rod configured to actuate the clamping assemblies between coupled and decoupled positions; providing a plurality of batteries, the batteries having posts; coupling individuals ones of the clamping assemblies to individuals ones of the battery posts to connect individual batteries.

Battery connector boards are provided. The boards can include at least one plate defining multiple openings configured to receive and electrically connect to a plurality of batteries, the plate including integrated circuitry configured to monitor and control individual and/or groups of batteries electrically coupled to the plate.

Battery banks are also provided. The banks can include: a plurality of batteries, at least a portion of which are aligned in columns; and; at least one battery connector assembly coupled to a column of batteries.

Battery connector assemblies are provided. The connector assemblies can include: a plurality of post coupling assemblies comprising a plurality of post clamping assemblies linked by individual rod assemblies, each of the rod assemblies including an actuator configured to couple/decouple the post clamping assemblies from battery posts.

### DRAWINGS

Embodiments of the disclosure are described below with reference to the following accompanying drawings.

FIG. 1 is an example bank of individual batteries according to an embodiment.

FIG. 2 is a bank of individual batteries connected with a battery connector assembly according to an embodiment.

FIGS. 3A and 3B are two embodiments of battery connector assemblies and methods.

FIGS. 4A, 4B, and 4C are battery connector assemblies in open and closed positions according to an embodiment.

FIG. 5 is a battery connector assembly according to an embodiment.

FIG. 6 is a battery connector assembly according to an embodiment.

FIG. 7 is a battery connector assembly according to an embodiment.

FIG. 8 is a cross-section of a portion of a battery connector assembly according to an embodiment.

FIG. 9 is a battery connector assembly according to an embodiment.

FIG. 10 is a battery connector assembly according to an embodiment.

FIG. 11 is a cross section of a portion of a battery connector assembly according to an embodiment.

FIG. 12 is a perspective view of a battery assembly according to an embodiment.

### DESCRIPTION

This disclosure is submitted in furtherance of the constitutional purposes of the U.S. Patent Laws “to promote the progress of science and useful arts” (Article 1, Section 8).

In developing banked battery supplies and storage it has been recognized that there may be obstacles to coupling individual batteries within the bank. These obstacles range from the physical limitations to repeated coupling and decoupling to the time consuming nature of coupling and decoupling larger banks. For example, in a bank containing 36 batteries there are 72 posts, and each post needs to be coupled to a grid individually; this is a time consuming process that manifests loose connections and/or wrong connections. Further, the connections made may not be able to be unmade. In some circumstances, coupling posts to grids are made with screw-type fittings and these fitting can become misthreaded and/or even cold-welded to the extent the grid cannot be decoupled from the battery without removing the post from the battery.

Embodiments of what is provided herein include connecting assemblies that can allow for the user to connect multiple batteries within a bank using a single actuator, without having to individually couple the individual posts of the batteries to a grid. Further, embodiments of the assemblies can provide a clamping engagement to the battery posts, thereby eliminating the misthread or cold-weld associated with the screw-type post fittings. As part of this disclosure, embodiments of the connector assemblies can also be configured to monitor battery parameters and engage and disengage discrete groups of batteries or single batteries alone as desired.

Battery banks are provided that can include a plurality of batteries. Individual batteries within the plurality can have at least two operable posts, negative and positive, for example. The batteries can be aligned as a column, and/or rows. Multiple columns may be provided and aligned to provide the batteries within the bank in columns and rows.

The banks can have at least one battery connector assembly coupled to a column of batteries within the bank. The battery connector assembly can include a clamping assembly and a rod assembly. The battery connector assembly can include an integrated circuit board. The batteries in the columns can be serially connected. The batteries in the columns can be connected in parallel.

The bank of batteries may also include a tray. The tray can be configured to receive a lower portion or base of the battery and/or align the batteries within the column. Where the batteries in the bank are aligned in rows, the tray can be configured to align the batteries in columns and rows. The tray can also be configured to retain battery fluid, for example, the tray can be constructed of acid resistant polymer material.

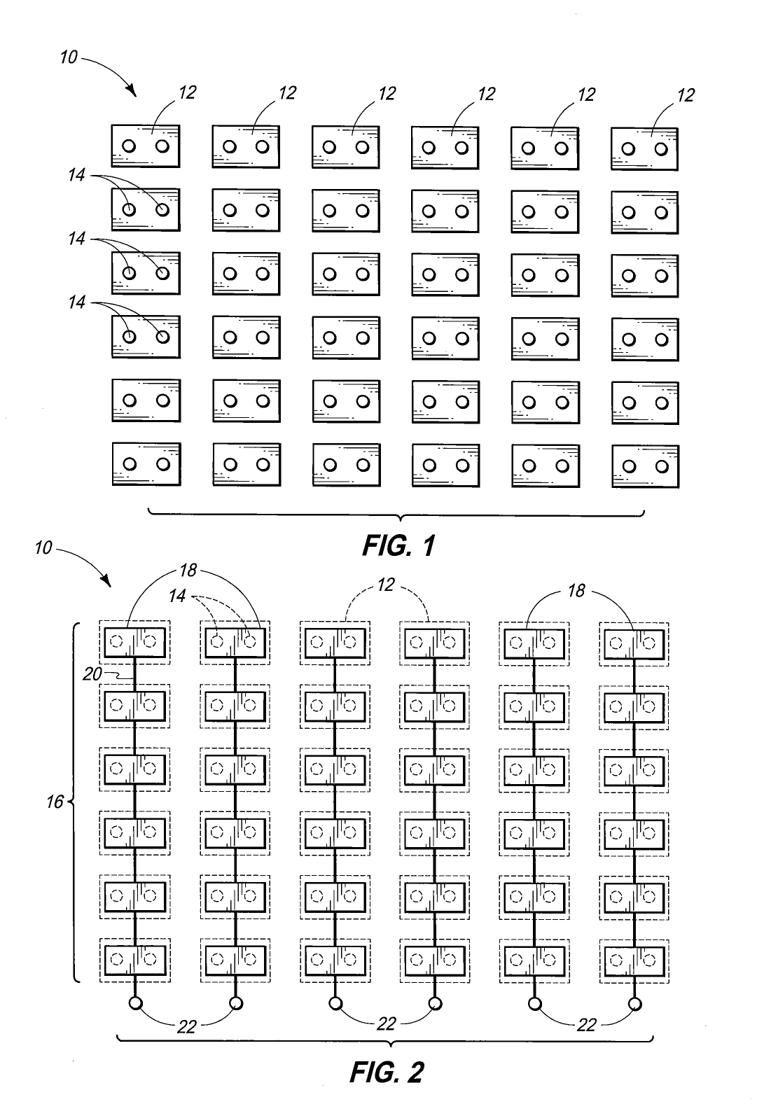

The battery banks, connector assemblies and battery connecting methods of the present disclosure are further described with reference to FIGS. 1-12. Referring first to FIG. 1, a bank of batteries 10 is shown having individual batteries 12 that include posts 14. These batteries can be single-celled batteries, such as nickel-metal-hydride or lithium ion batteries, for example. The posts 14 can represent positive and negative posts of the individual batteries. As shown in FIG. 1, the bank is in a 6×6 configuration. Bank 10, as well as other banks, may be defined in terms of columns and rows. Banks of batteries may be comprised of six rows and 12 columns of batteries, for example. Other configurations are contemplated and may be utilized, and the battery bank can exist from as few as two batteries to as many as multiple batteries serially and/or connected in parallel, for example.

Further, a tray (not shown) may be associated with each bank of multiple banks of batteries. The tray may define recesses configured to align individual batteries of the bank spatially in relation to one another. In accordance with example implementations, the tray may also be associated with the battery connecting assemblies of the present disclosure. The tray may also be configured to contain battery fluid such as electrolytes that may exit one or more batteries within the bank. The spatial alignment of the batteries by the tray can transfer to the spatial alignment of the posts of the batteries to the connector assemblies.

Referring next to FIG. 2, bank 10 is shown that includes a plurality of battery connector assemblies 16. The battery connector assembly can include a plurality of post coupling assemblies. The post coupling assemblies can include a plurality of post clamping assemblies linked by individual rod assemblies, each of the rod assemblies including an actuator configured to couple/decouple the post clamping assemblies from battery posts. The post clamping assemblies can be biased in the decoupled position. In the decoupled position, the clamping assemblies can be configured to receive a post of a battery. Force applied to the clamping assemblies can act against the bias engaging the posts and/or coupling with the posts.

The rod assembly can include a continuous rod extending from the actuator through the clamping assemblies to a terminus. As an example, at least a portion of the rod assembly can be insulative. The rod assembly can also include a plurality of sleeves spacing the clamping assemblies along the rod. Individual ones of the plurality of sleeves can be either conductive or insulative. The rod assembly can include at least one sleeve configured to receive the terminus of the rod, the terminus of the rod being threaded and the sleeve being configured to receive the threads.

The connector assembly can include a plate associated with at least some of the post coupling assemblies. The plate can be in electrical contact with at least one of the post clamping assemblies. The plate can include at least two plates, a supportive plate and a circuit board. The plate can be configured to facilitate the control and/or monitoring of one or more batteries connected to the post clamping assemblies.

Methods for connecting batteries are provided. The methods can include aligning a series of clamping assemblies along a rod configured to actuate the clamping assemblies between coupled and decoupled positions. The method can include providing a plurality of batteries, the batteries having posts. The method can also include coupling individuals ones of the clamping assemblies to individuals ones of the battery posts to connect individual batteries.

The methods for connecting batteries can also include engaging an actuator to couple or decouple the clamping assemblies from the battery posts. The clamping assemblies can be biased in the decoupled position, the engaging the actuator to couple the clamping assemblies to the battery posts can include applying force against the bias. The applying the force against the bias can include rotating the rod of the assembly along its lengthwise axis. According to example implementations, the rotating can engage a threaded sleeve at the rod terminus applying force to the clamping assemblies, for example. The coupling of the plurality of batteries can include manipulating a single actuator.

The methods of connecting batteries can also include associating a plate with the clamping assemblies, at least a portion of the plate being in electrical connection with at least some of the clamping assemblies. The plate can be configured to provide for the monitoring and/or control of battery parameters of individual batteries within and across columns, for example. The methods of connecting batteries can also include providing a plurality of connector assemblies, individual ones of the connector assemblies including the plurality of clamping assemblies aligned along the rod. The methods of connecting batteries can also include providing the plurality of batteries in columns of batteries, individual ones of the connector assemblies being associated with individual columns of batteries.

According to example implementations, the assemblies can be used to connect multiple batteries within a column or multiple columns as desired. Alternative implementations may connect batteries of the entire bank or portions of a bank. The batteries may be aligned in series or in parallel or combinations of both. Connector assemblies 16 can include post coupling assemblies 18 mechanically linked via rods 20. Individual ones of connector assemblies 16 can include an actuator assembly 22. Coupling assemblies 18 can be configured to move between an open and closed position in relation to posts 14 using rods 20 and actuator 22. In accordance with example implementations, coupling assemblies 18 can complete an electrical contact with posts 14 in the closed position and disconnect that electrical contact in the open position. Rods 20 may be insulative or conductive and may be constructed of multiple components, such as a pipe having a rod therein, for example. Actuator 22 can be mechanically connected to rods 20 providing for the opening and closing of assemblies 18.

As can be seen in FIG. 2, individual connector assemblies 16 are associated with individual columns of batteries 12 in bank 10. This is only an embodiment of a connector assembly. It is contemplated that individual connector assemblies can connect batteries within individual or multiple rows or columns.

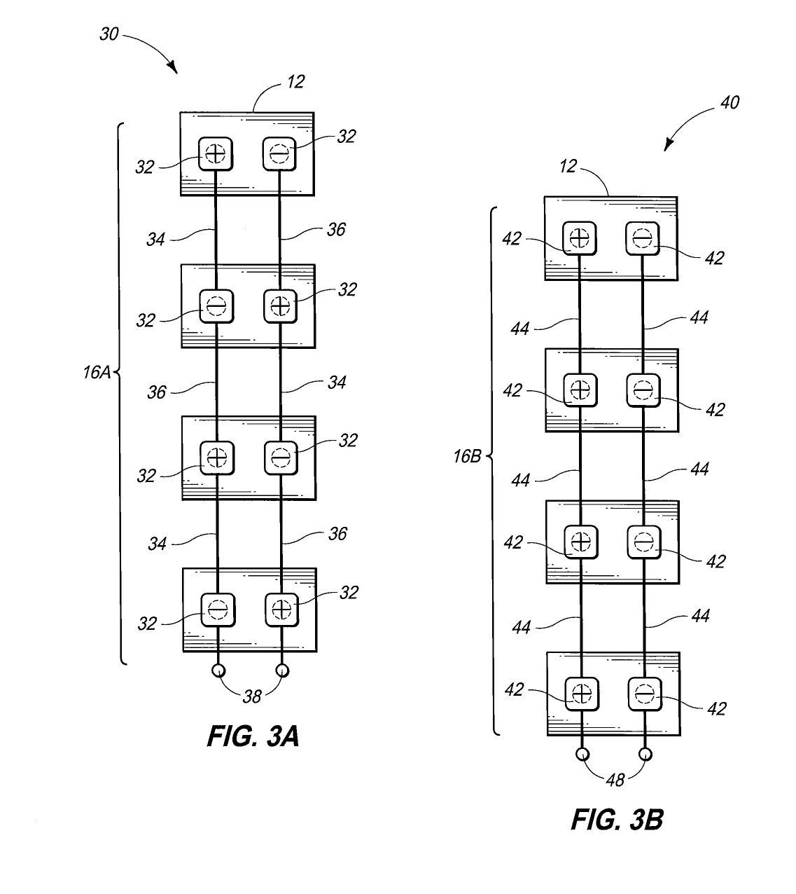

Referring to FIGS. 3A and 3B, at least two embodiments are shown of assembly 16, 16A for use with serial alignment of batteries and 16B for use with parallel alignment of batteries. Referring first to FIG. 3A in a serial alignment, the assembly 16A can engage alternating positive and negative posts of batteries 12 within bank 30, for example. Assembly 16A can include post coupling assemblies 32 mechanically coupled to both conductive rods 34 and insulative rods 36. In accordance with example implementations, assembly 16A can include actuator 38 configured to operatively open and close post coupling assemblies 32. By alternating the alignment of the positive and negative posts of individual batteries 12 within a column/row and alternating conductive and insulative rods 34 and 36, batteries within bank 30 can be electrically connected in a serial manner.

Referring to FIG. 3B, batteries may be connected in parallel, for example, by providing bank 40 having batteries with aligned posts and connecting them with connector assembly 16B. Assembly 16B includes post coupling assembly 42 connected mechanically via rods 44 and operatively connected to actuator 48. In accordance with example implementations, rods 44 can be conductive.

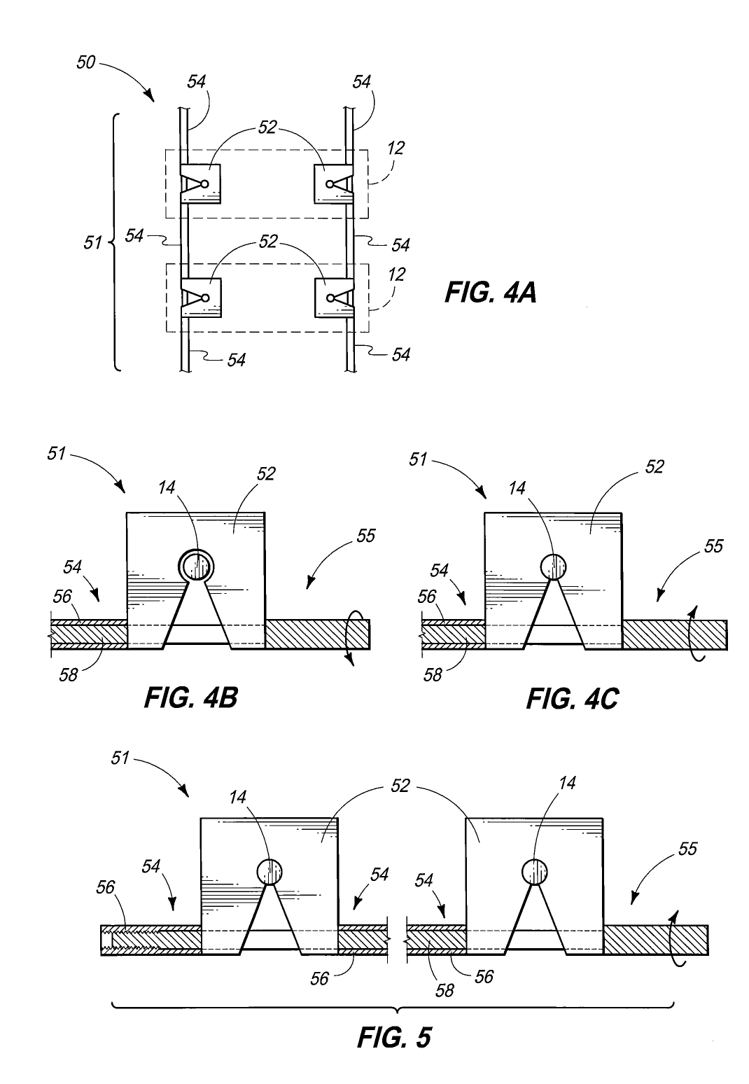

Referring to FIGS. 4A-4C, views of portions of connector assemblies according to an embodiment are shown. Referring first to FIG. 4A, a bank 50 of batteries 12 is shown connected via connector assemblies 51. Assemblies 51 include rods 54 coupled to post coupling assemblies 52. As is depicted, assembly 52 can be configured to provide for the clamping of posts 14. As can be seen, these assemblies 52 can be mechanically connected via rod assemblies 54. As desired, rods 54 can be configured to be conductive or insulative. For example, for serial connections, portions of the rods such as the sleeves can be insulative and a portion of the rod extending through assembly 52 can be insulated with insulative material from assembly 52. Where parallel alignment is desired, an entirety of the rod can be conductive with the exception of the actuator which can be constructed of an insulative material.

Referring next to FIGS. 4B and 4C, a portion of connector assemblies 51 are shown in at least two positions, an open position, and a closed position. Referring first to FIG. 4B, assembly 52 is shown in an open position operatively engaged with actuator 55. Assembly 52 can be biased in the open position for example. Actuator 55 can be configured to rotate rod 58 along its lengthwise axis in the counter-clockwise direction and allow for assembly 52 to extend to its bias thereby opening assembly 52. Alternatively and with reference to FIG. 4C, rod 58 with actuator 55 can be rotated in a direction opposing that in FIG. 4B. Clockwise rotation of rod 58 can exert force against assembly 52 thereby closing assembly 52 to engage post 14.

Referring to FIG. 5 and according to another embodiment, these coupling assemblies 52 can be mechanically linked to operate in unison or sequentially through the application or release of force from actuator 55. In accordance with example implementations, application of force via actuator 55 can be applied to assemblies 52 connected in series via rods 54 to close or open assemblies 52. For example, at a terminus of rod 58, sleeve 56 can be threaded and rod 58 can include complimentary threads. By rotating actuator 55 these threads can be engaged by either releasing or applying force to the bias of a series or group of assemblies 52 aligned along rod 58.

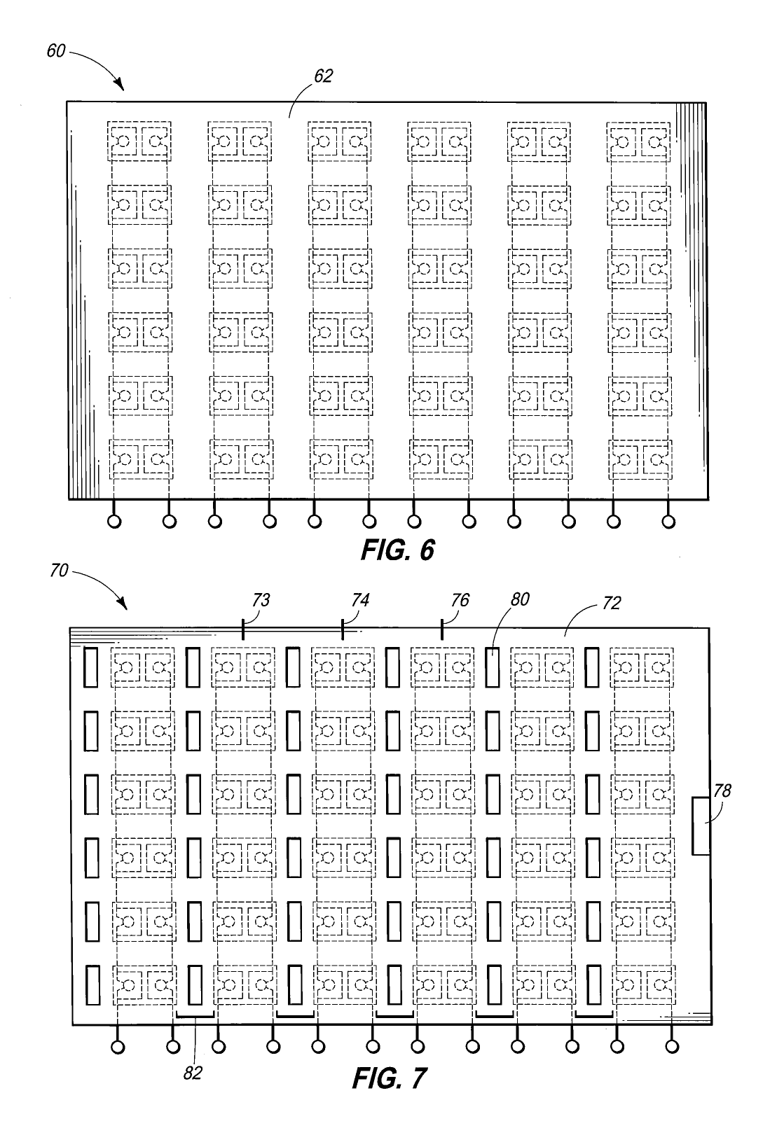

Referring next to FIG. 6, an embodiment of a connector assembly 60 is shown having plate 62 therein. Plate 62 can be constructed of high density polyethylene for example and can be coupled to individual or multiple post coupling assemblies. The position for the openings in the coupling assemblies can be fixed relative to plate 62. According to example implementations, plate 62 can define openings for posts of batteries. Plate 62 can include a single plate or it may be part of a multiplate assembly.

Battery connector boards are provided that can include at least one plate defining multiple openings configured to receive and electrically connect to a plurality of batteries. One or more of the multiple openings can be configured to conductively engage one or more posts of the plurality of batteries. The posts can be threaded and coupled to the plate via complimentary threaded nut.

The board can include at least two plates, an integrated circuit plate above a supportive plate. The integrated circuit plate can include integrated circuitry configured to monitor and control individual and/or groups of batteries electrically coupled to the plate. This integrated circuitry can include and/or be configured to interface with processing and/or memory circuitry. The plate can be configured as a circuit board array. The board can include vents configured to provide for the exchange of air between upper and lower surfaces of the plate.

The integrated circuitry can include one or more of jumpers, switches, shunts, and/or embedded fusing. The board of claim 21 further comprising PIN connectors. The board can include a plurality of switches, individual ones of the switches having a unique identifier. The board can also include bus connectors.

The processing and memory circuitry can be a part of a processing unit that can include one or more microprocessors, one or more support circuits, circuits that include power supplies, clocks, input/output interfaces, circuitry, and the like. Generally, all computer processing units described herein can be of the same general type. The processing and/or memory circuitry can include a memory that can include random access memory, read only memory, removable disc memory, flash memory, and various combinations of these types of memory. The memory can be referred to as a main memory and be part of a cache memory or buffer memory. The memory can store various software packages and components such as an operating system.

The processing and/or memory circuitry can be configured to monitor battery parameters and/or reconfigure battery connections to the board. The battery parameters can include one or more of temperature, thermal conductivity, voltage, current, and/or impedence.

Methods for controlling the usage of individual and/or groups of batteries within a bank of batteries are provided. The methods can include coupling an integrated circuit board to the batteries within the bank of batteries. The coupling the integrated circuit board to the batteries can include mechanically engaging individual posts of the batteries with individual openings within the circuit board. The method can also include providing conductive material along the edges of the board defining the openings.

The methods can also include monitoring the battery parameters of individual and/or groups of batteries within a bank of batteries using the integrated circuit board, for example. The monitoring the battery parameters can include monitoring one or more of the temperature, thermal conductivity, voltage, current, and/or impedence associated with batteries. The monitoring the can include one or more of storing the battery parameter data with memory circuitry and/or comparing stored battery parameter data with standard battery parameter data using processing circuitry, for example. The methods can also include engaging and/or disengaging the individual and/or groups of batteries using the circuit board.

The methods can also include processing battery parameter data using processing circuitry to engage and/or disengage the individual and/or groups of batteries.

The methods can also include transferring power between portions of the board. The transferring can include open/closing individual or groups of switches in the board.

In accordance with other embodiments of the disclosure and with reference to FIG. 7, assembly 70 is shown that includes a control and monitoring plate 72. Plate 72 may be used alone or in combination with plates such as plate 62. Plate 72 can be a high dielectric MTL and patterned as a circuit board array that can include connections that may be utilized to monitor the state of battery health of the bank, discrete portions of the bank, and/or individual batteries within the bank. Parameters that may be used to monitor the state of battery health include, but are not limited to: temperature, thermal conductivity, voltage, current, and impedance, for example. In accordance with example implementations, plate 72 can include temperature connections 73, thermal conductivity connections 74, and voltage sensors 76.

Plate 72 can also be configured to monitor and control the use of banks, discrete portions of banks, and/or individual batteries within banks. For example, plate 72 can include one or more bus connectors 78 that can be configured as PIN connectors having designated pins associated with designated control or monitoring parameters. In other embodiments, connectors 78 may be part of a processing and memory device associated with plate 72 that may be accessed from a separate processing device for example. In these embodiments, the processing and memory device of plate 72 may collect and store data as a result of monitoring and/or controlling the batteries and may provide the collected data to the separate processing device. Furthermore, in some cases, the processing and memory device of plate 72 may analyze the collected data and take action based on the analysis. For example, the processing and memory device of plate 72 may analyze the collected data, determine that an undesirable condition exists, and, in response, generate an alarm.

Either one or both of plates 62 and 72 can include vents 80 to allow for heat removal from a battery bank. Further, plate 72 can include jumpers 82 that can allow for the transfer of power between sections such as rows of batteries. These jumpers may be moveable as well. Further, plate 72 can include embedded fusing to allow for the isolation of predefined regions upon current overload.

According to example implementations, plate 72 can include switches having identifiers that provide for the isolation of individual cells along the coupling assembly. In accordance with an example implementation, all rods of connector assemblies associated with assembly 70 can be insulative. Plate 72 can have conductive contact with coupling assemblies and provide for conduction between posts via lines within plate 72. These conductive lines may have switches therein (e.g., IGBTs) and be identified as a region or sector of the battery bank. According to example implementations, plate 72 can be monitored via a computer to determine battery parameters, and using the computer, individual batteries or groups of batteries may be taken off-line or returned to being on-line as desired by an operator. As an example, for batteries in serial connection conductive lines can be included in plate 72 that overlap predetermined batteries within a series and these conductive lines can include switches that can be manipulated via a processor. To remove a specific battery from a serial group of batteries, one or more of the switches can be engaged to isolate the battery from the series, without disabling the rest of the batteries of the series. Similarly, one or more of the switches can be engaged to remove one of the batteries of a parallel connection of batteries from the parallel connection.

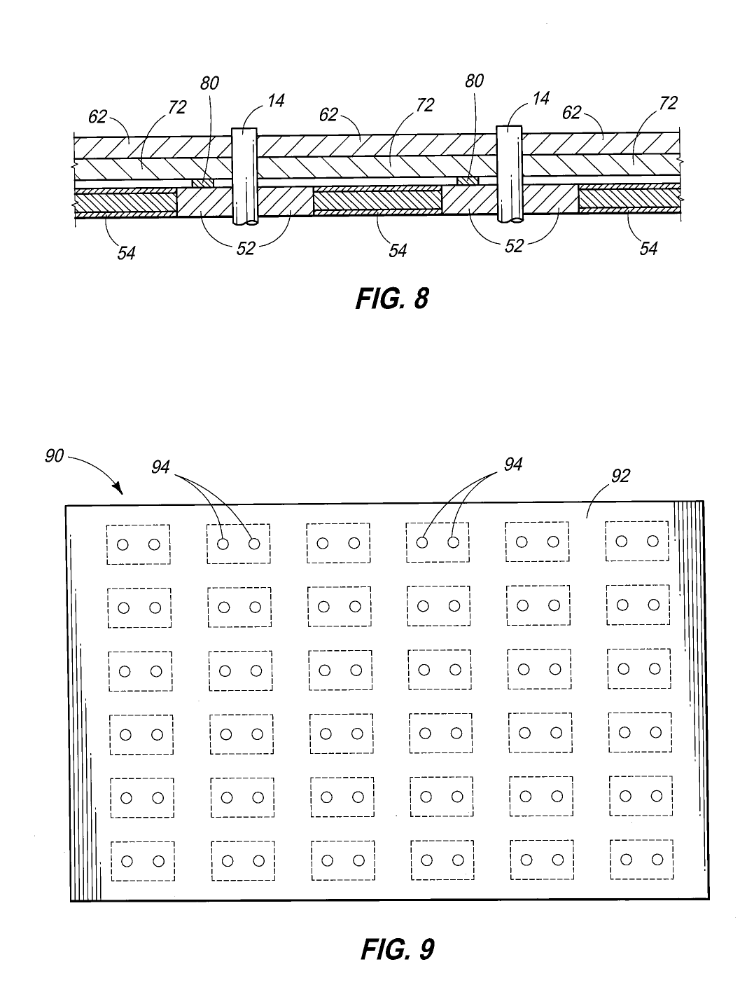

Referring next to FIG. 8, a cross-section of a connector assembly according to an embodiment is shown. As is depicted, post 14 can be operatively engaged with coupling assembly 52 having rods 54 therebetween. According to an example implementation, plates 62 and 72 may be aligned where plate 62 is a supportive substrate such as a high density polyethylene and plate 72 is a circuit or controlling substrate such as a circuit board, for example. While shown with plate 72 in the lower portion and plate 62 in the upper portion, it is conceivable that these plates can be flipped where plate 72 is on the upper portion and plate 62 is on the lower portion. In accordance with example implementations, assemblies 52 may be coupled with plate 72 via contact 80, for example. Where plate 72 is spaced from assembly 52 by plate 62, for example, contact 80 may extend through plate 62. Accordingly, contact of assembly 52 with plate 72 can provide for the engagement or disengagement as desired of discrete groups or portions of a battery bank. In some implementations, rods connecting assemblies 52 may be entirely insulated from assemblies 52 and the conductive contact may be only via contact 80 to plate 72.

Referring to FIG. 9 an embodiment of a connector assembly 90 is shown having plate 92. As discussed above, plate 92 can be of high density polyethylene as plate 62 is constructed with the exception that plate 92 is not coupled to a mechanical coupling assembly. Plate 92 can include openings 94 configured to engage posts of battery cells for example. Openings 94 can be defined by conductive material that can conductively embrace posts of battery cells. This conductive material can also be of sufficient rigidity to allow for the coupling of plate 92 to posts via connectors such as bolts to a threaded post for example. Plate 92 can include a single plate or it may be part of a multiplate assembly.

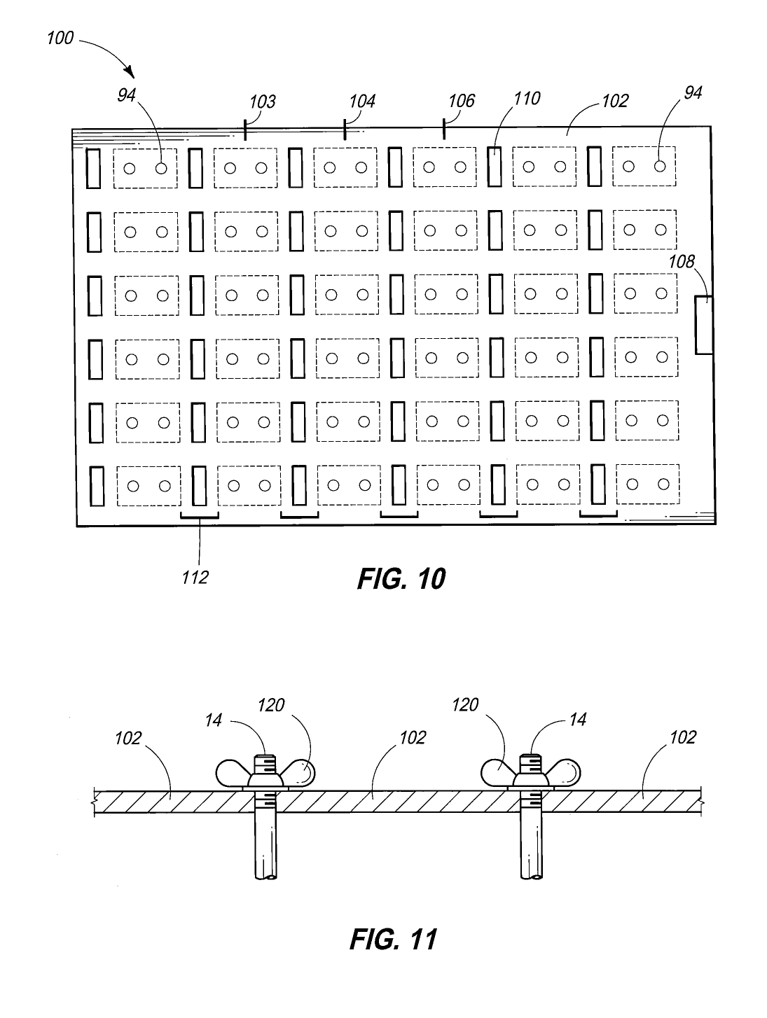

In accordance with another embodiment and with reference to FIG. 10, assembly 100 is shown that includes a control and monitoring plate 102. Like plate 92, plate 102 can have openings configured to electrically couple with posts of battery cells. Plate 102 may be used alone or in combination with plates such as plate 92. Plate 102 can be a high dielectric MTL and patterned as a circuit board array that can include connections that may be utilized to monitor the state of battery health of the bank, discrete portions of the bank, and/or individual batteries within the bank. Parameters that may be used to monitor the state of battery health include, but are not limited to: temperature, thermal conductivity, voltage, current, and impedance, for example. In accordance with example implementations, plate 102 can include temperature connections 103, thermal conductivity connections 104, and voltage sensors 106.

Plate 102 can also be configured to monitor and control the use of banks, discrete portions of banks, and/or individual batteries within banks. For example, plate 102 can include one or more bus connectors 108 that can be configured as PIN connectors having designated pins associated with designated control or monitoring parameters. In other embodiments, connectors 108 may be part of a processing and memory device associated with plate 102 that may be accessed from a separate processing device for example. In these embodiments, the processing and memory device of plate 102 may collect and store data as a result of monitoring and/or controlling the batteries and may provide the collected data to the separate processing device. Furthermore, in some cases, the processing and memory device of plate 102 may analyze the collected data and take action based on the analysis. For example, the processing and memory device of plate 102 may analyze the collected data, determine that an undesirable condition exists, and, in response, generate an alarm.

Either one or both of plates 92 and 102 can include vents 110 to allow for heat removal from a battery bank. Further, plate 102 can include jumpers 112 that can allow for the transfer of power between sections such as rows of batteries. These jumpers may be moveable as well. Further, plate 102 can include embedded fusing to allow for the isolation of predefined regions upon current overload. According to example implementations, plate 102 can include switches having identifiers that provide for the isolation of individual cells or posts of cells.

According to example implementations, plate 102 can be monitored via a computer to determine battery parameters, and using the computer, individual cells, batteries and/or groups of batteries may be taken off-line or returned to being on-line as desired by an operator. As an example, for batteries in serial connection conductive lines can be included in plate 102 that overlap predetermined batteries within a series and these conductive lines can include switches that can be manipulated via a processor. To remove a specific cell or battery from a serial group of batteries, one or more of the switches can be engaged to isolate the cell or battery from the series, without disabling the rest of the batteries of the series. Similarly, one or more of the switches can be engaged to remove one of the batteries of a parallel connection of batteries from the parallel connection.

As another example, plate 102 can have shunts incorporated therein consistent with serial or parallel design of the bank. Power may be provided via these shunts to an entirety or discrete portions of the bank to facilitate equalization of the bank or portions of the bank as desired. In accordance with example implementations, using the shunts specific batteries or groups of batteries may be bypassed. In particular embodiments, batteries may be removed from parallel configurations.

Referring next to FIG. 11, a cross-section of a connector assembly according to an embodiment is shown. As is depicted, post 14 can be operatively engaged with plate 102 via nut 120 for example. Accordingly, contact of posts 14 with plate 102 can provide for the engagement or disengagement as desired of discrete groups or portions of a battery bank.

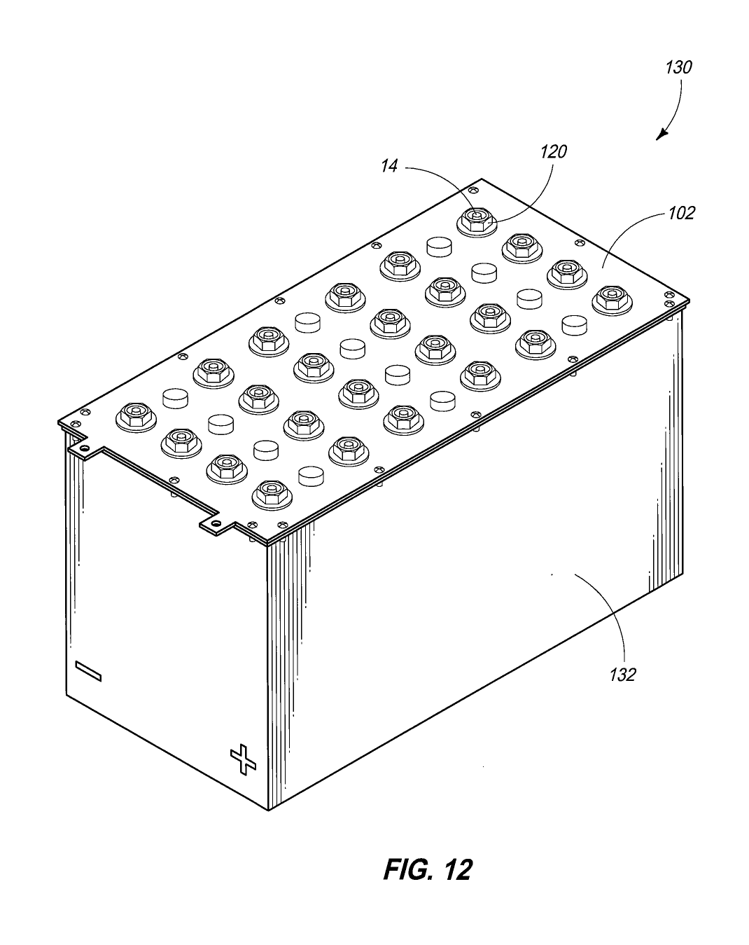

Referring next to FIG. 12 a perspective view of a battery assembly 130 is shown having plate 102 engaging posts 14 of battery cells within housing 132. Posts 14 can be coupled to plate 102 via bolts 120, for example. Housing 132 can be configured to contain electrolytic solution as well as discrete cells.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect. The invention is, therefore, claimed in any of its forms or modifications within the proper scope of the appended claims appropriately interpreted in accordance with the doctrine of equivalents.

1. A battery connector assembly comprising a plurality of post coupling assemblies comprising a plurality of post clamping assemblies linked by individual rod assemblies, each of the rod assemblies including an actuator configured to couple/decouple the post clamping assemblies from battery posts.

2. The battery connector assembly of claim 1 wherein the post clamping assemblies are biased in the decoupled position.

3. The battery connector assembly of claim 1 wherein the rod assembly comprises a continuous rod extending from the actuator through the clamping assemblies to a terminus.

4. The battery connector assembly of claim 3 wherein the rod assembly further comprises a plurality of sleeves spacing the clamping assemblies along rod.

5. The battery connector assembly of claim 4 wherein individual ones of the plurality of sleeves are either conductive or insulative.

6. The battery connector assembly of claim 3 wherein the rod assembly includes a sleeve configured to receive the terminus of the rod, the terminus of the rod being threaded and the sleeve being configured to receive the threads.

7. The battery connector assembly of claim 1 further comprising a plate associated with at least some of the post coupling assemblies.

8. The battery connector assembly of claim 7 wherein the plate is in electrical contact with at least one of the post clamping assemblies.

9. The battery connector assembly of claim 7 wherein the plate comprises at least two plates, a supportive plate and a circuit board.

10. The battery connector assembly of claim 7 wherein the plate is configured to facilitate the control and/or monitoring of one or more batteries connected to the post clamping assemblies.

11. The battery connector assembly of claim 1 wherein at least a portion of the rod assembly is insulative.

12. A method for connecting batteries comprising:
aligning a series of clamping assemblies along a rod configured to actuate the clamping assemblies between coupled and decoupled positions;
providing a plurality of batteries, the batteries having posts; and
coupling individuals ones of the clamping assemblies to individuals ones of the battery posts to connect individual batteries.

13. The method of claim 12 further comprising engaging an actuator to couple or decouple the clamping assemblies from the battery posts.

14. The method of claim 13 wherein the clamping assemblies are biased in the decoupled position, the engaging the actuator to couple the clamping assemblies to the battery posts comprising applying force against the bias.

15. The method of claim 14 wherein the applying force against the bias comprises rotating the rod of the assembly along its lengthwise axis.

16. The method of claim 12 wherein the coupling of the plurality of batteries comprises manipulating a single actuator.

17. The method of claim 12 further comprising associating a plate with the clamping assemblies, at least a portion of the plate being in electrical connection with at least some of the clamping assemblies.

18. The method of claim 12 further comprising providing a plurality of connector assemblies, individual ones of the connector assemblies comprising the plurality of clamping assemblies aligned along the rod.

19. The method of claim 18 further comprising providing the plurality of batteries in columns of batteries, individual ones of the connector assemblies being associated with individual columns of batteries.

20. The method of claim 19 further comprising associating a plate with the clamping assemblies, at least a portion of the plate being in electrical connection with at least some of the clamping assemblies, the plate being configured to provide for the monitoring and/or control of battery parameters of individual batteries within and across columns.

21. A battery connector board comprising at least one plate defining multiple openings configured to receive and electrically connect to a plurality of batteries, the plate including integrated circuitry configured to monitor and control individual and/or groups of batteries electrically coupled to the plate.

22. The board of claim 21 further comprising vents configured to provide for the exchange of air between upper and lower surfaces of the plate.

23. The board of claim 21 wherein the integrated circuitry includes one or more of jumpers, switches, shunts, and/or embedded fusing.

24. The board of claim 21 wherein one or more of the multiple openings is configured to conductively engage one or more posts of the plurality of batteries.

25. The board of claim 24 wherein the posts are threaded and coupled to the plate via complimentary threaded nut.

26. The board of claim 21 comprising at least two plates, an integrated circuit plate above a supportive plate.

27. The board of claim 21 wherein the plate is patterned as a circuit board array.

28. The board of claim 21 further comprising processing and memory circuitry.

29. The board of claim 28 wherein the processing and memory circuitry is configured to monitor battery parameters and/or reconfigure battery connections to the board.

30. The board of claim 29 wherein the battery parameters include one or more of temperature, thermal conductivity, voltage, current, and/or impedence.

31. The board of claim 21 further comprising bus connectors.

32. The board of claim 21 further comprising PIN connectors.

33. The board of claim 21 further comprising a plurality of switches, individual ones of the switches having a unique identifier.

34. A method for controlling the usage of individual and/or groups of batteries within a bank of batteries, the method comprising:
coupling a integrated circuit board to the batteries within the bank of batteries;
monitoring the battery parameters of individual and/or groups of batteries within a bank of batteries; and
engaging and/or disengaging the individual and/or groups of batteries through the circuit board.

35. The method of claim 34 wherein the coupling the integrated circuit board to the batteries comprises mechanically engaging individual posts of the batteries with individual openings within the circuit board.

36. The method of claim 34 further comprising providing conductive material along the edges of the board defining the openings.

37. The method of claim 34 wherein the monitoring the battery parameters comprises monitoring one or more of the temperature, thermal conductivity, voltage, current, and/or impedence associated with batteries.

38. The method of claim 34 wherein the monitoring the battery parameters comprise storing the battery parameter data with memory circuitry.

39. The method of claim 34 wherein the monitoring the battery parameters comprises comparing stored battery parameter data with standard battery parameter data using processing circuitry.

40. The method of claim 34 further comprising processing battery parameter data using processing circuitry to engage and/or disengage the individual and/or groups of batteries.

41. The method of claim 34 further comprising transferring power between portions of the board.

42. The method of claim 40 wherein the transferring comprises open/closing individual or groups of switches in the board.

43. A battery bank comprising:
a plurality of batteries, at least a portion of which are aligned in columns; and
at least one battery connector assembly coupled to a column of batteries.

44. The battery bank of claim 43 further comprising a tray.

45. The battery bank of claim 44 wherein the tray is configured to align the batteries within the column.

46. The battery bank of claim 44 further comprising batteries aligned in rows, the tray configured to align the batteries in columns and rows.

47. The battery bank of claim 44 wherein the tray is configured to retain battery fluid.

48. The battery bank of claim 43 wherein the batteries in the columns are serially connected.

49. The battery bank of claim 43 wherein the batteries in the columns are connected in parallel.

50. The battery bank of claim 43 wherein the battery connector assembly comprises a clamping assembly and a rod assembly.

51. The battery bank of claim 43 wherein the battery connector assembly comprises an integrated circuit board.
